(19) United States
(12) Patent Application Publication
(10) Pub. No.: US 2009/0075032 A1
(43) Pub. Date: Mar. 19, 2009

(54) Multiple ply web supply roll for form, fill, seal packaging machinery

(76) Inventor: Christopher C. Rutter, Oakland, CA (US)

Correspondence Address: ROCKEY, DEPKE & LYONS, LLC, SEARS TOWER, SUITE 5450, CHICAGO, IL, 60606-6306, US

(21) Appl. No.: 11/901,305

(22) Filed: Sep. 17, 2007

(51) Int. Cl. B32B 23/02; B32B 27/32; B32B 27/36; B32B 27/38; B32B 9/04; B65H 81/00

(52) U.S. Cl. 428/194; 156/188; 428/411.1; 428/412; 428/413; 428/473.5; 428/474.4; 428/480; 428/500; 428/521; 428/523

(57) ABSTRACT

The present invention provides a roll of film material having: (1) a first web of film having a first planar surface and a first set of opposed lateral edges; (2) a second web of film having a second planar surface and a second set of opposed lateral edges, a portion of the second planar surface being in contact with the first planar surface but not being attached thereto, the second set of opposed lateral edges being in registration with the first set of opposed lateral edges; and (3) the first web of film and the second web of film being wound about an axis transversely disposed to the first set of opposed lateral edges to define a roll of film material.

### CROSS-REFERENCE TO RELATED APPLICATION

This application claims priority to U.S. patent application Ser. No. 11/713,471 filed on Mar. 2, 2007, which is incorporated herein in its entirety and made a part hereof.

### FEDERALLY SPONSORED RESEARCH OR DEVELOPMENT

Not Applicable.

### BACKGROUND OF THE INVENTION

1. Technical Field

The present invention provides a roll of container sidewall material having a first ply and a second ply wound together about a common axis to form a stack of layers along a radius of the roll alternating between the first ply and the second ply. The roll can have a leading edge of the first ply and the second ply fed into a vertical form, fill and seal machinery where the machinery forms a filled container having: (1) the first ply and the second ply forming a first wall of the container and an opposed second wall is formed from a different supply of material, or (2) the first ply and the second ply form both opposed walls of the container or (3) the first ply forms a first wall of the container and the second ply forms an opposed second wall of the container.

2. Background Art

Collapsible plastic bags are often used to store liquid products such as chemicals, soft drink syrup, wine, fruit juices, medical fluids and food condiments. For certain applications the plastic bags are typically housed in a corrugated paperboard box to aid in the transporting, handling and dispensing of the product. Such packaging systems are commonly referred to as “bag-in-box” packaging systems.

The plastic bags typically have sidewalls sealed along a peripheral seam to define a fluid containing chamber. A spout or a fitment provides access to the fluid chamber for filling and dispensing the product within the bag. Liquid filled containers are often provided using form, fill and seal equipment. The present invention provides a roll of a multiple-ply material for forming containers, a method for forming a spool of multiple-ply material for use in packaging machinery, and a method for forming containers from such multiple-ply material.

These and other aspects and attributes of the present invention will be discussed with reference to the following drawings and accompanying specification.

### BRIEF DESCRIPTION OF THE DRAWINGS

FIG. 1 is a perspective view of a roll of container wall material having consecutive layers of a first ply and a second ply;

FIG. 2 is an end view of the roll of FIG. 1;

FIG. 3 is a schematic view of one method for forming the roll of FIG. 1 from a first preformed roll of the first ply and a second preformed roll of the second ply;

FIG. 4 is a schematic view of another method for forming the roll of FIG. 1 by combining together extrudates or laminates of the first ply and the second ply;

FIG. 5 is a schematic view of another method for forming the roll of FIG. 1 by combining an extrudate or laminate of the first ply and a second ply on a preformed roll;

FIG. 6 is a schematic view of a vertical form, fill and seal machinery;

FIG. 7 is a side elevation view in vertical cross section of a fitment;

FIG. 8 is a perspective view of a fluid container having a fitment on a planar surface of a wall of the container;

FIG. 9 is a perspective view of a fluid container having a fitment extending through a seam or end wall of the container;

FIG. 10 is a cross-sectional view of a multiple layer film structure; and

FIG. 11 is a cross-sectional view of a monolayer film structure.

### DETAILED DESCRIPTION OF THE INVENTION

While this invention is susceptible of embodiment in many different forms, there is shown in the drawings, and will be described herein in detail, specific embodiments thereof with the understanding that the present disclosure is to be considered as an exemplification of the principles of the invention and is not intended to limit the invention to the specific embodiments illustrated.

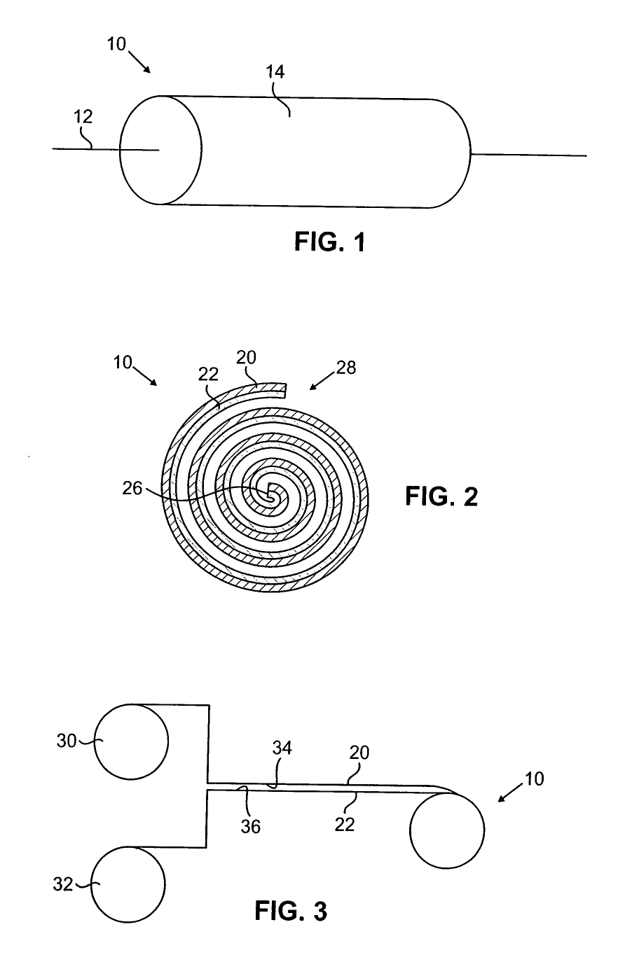

FIG. 1 shows a roll or spool 10 of material for fabricating a container using packaging machinery such as vertical form, fill and seal machinery. The roll 10 has a longitudinal axis 12 about which the material 14 is wound. As shown in FIGS. 1 and 2, the roll when viewed along a radius, the first ply and the second ply form consecutive stacked layers. The roll is formed by placing a first ply of material 20 into surface contact with a second ply 22 of material and then winding both plies about the axis 12. FIG. 2 shows that the first ply 20 and the second ply 22 are coextensive and form stacked layers from the center of the roll 26 to a leading edge 28 of the roll. However, it is contemplated that either the first ply or the second ply could be used exclusively as a starter section at the center of the roll or as an outer section at the leading edge of the roll without departing from the invention. The outer section could be used to protect the roll from cosmetic or physical damage such as scratches or punctures and the like. Also, while the roll 10 shows two plies of material it is contemplated additional plies could be used such as three to ten plies without departing from the scope of the present invention. The material for fabricating the plies will be discussed in greater detail below, but, in short, can be selected from polymeric material, paper, and metal foil.

FIG. 3 shows one method of forming the roll 10 by drawing the first web of material from a roll 30 of preformed material and the second web of material from a second roll 32 of preformed material, positioning the first ply and the second ply to place their respective opposed lateral edges into registration with one another and then bringing a planar surface 34 of the first ply into surface contact with the second ply and winding the stacked plies about the axis 12 to form roll 10. Thus, in one preferred form of the invention the first ply is not connected to the second ply. In another preferred form of the invention, the first ply will be connected to the second ply along one or both pairs of each of the plies opposed lateral edges. When both of each plies lateral edges are attached or connected to one another the first ply and the second ply form a tube of material that is wound about the axis 12 to form the roll 10. The first ply can be connected to the second ply through any suitable technique well known in the art such as by inductive or conductive heat sealing, or welding, or by using an adhesive. The seal between the first ply and the second ply can be a permanent seal or a peel seal. A permanent seal is one that cannot be separated without damaging the first ply or the second ply. A peel seal is one that is meant to be separated by hand or machine without damaging the first ply or the second ply. Each of the plies of the tube of material will have a central planar surfaces extending between the lateral edges and one ply's planar surface will remain unattached to the other ply's planar surface. It is also contemplated that the first ply can be connected to the second ply in locations other than the lateral edges and can form a continuous line over a portion of the length of the plies or can be intermittent lines or spots.

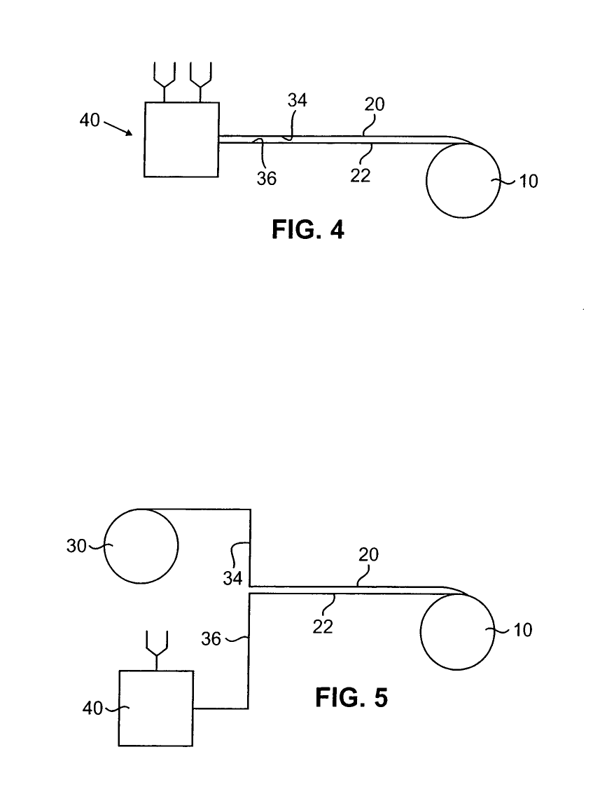

FIG. 4 shows an alternative method for forming the spool 10. In this embodiment, the first ply and the second ply 20, 22 are provided from equipment used to form the material 40 such as an extrusion die, coextrusion die, lamination equipment, extrusion lamination, blown extrusion and the like and the first ply and the second ply are cooled, quenched, set or otherwise placed in a form suitable to be placed in surface contact with one another and wound into the roll 10.

FIG. 5 shows yet another alternative embodiment for forming the spool 10 which is a combination of the embodiments shown in FIGS. 3 and 4. In the embodiment shown in FIG. 5, the first ply of material 20 is drawn from the preformed roll of material 30 and the second ply of material is drawn from the material forming equipment 40.

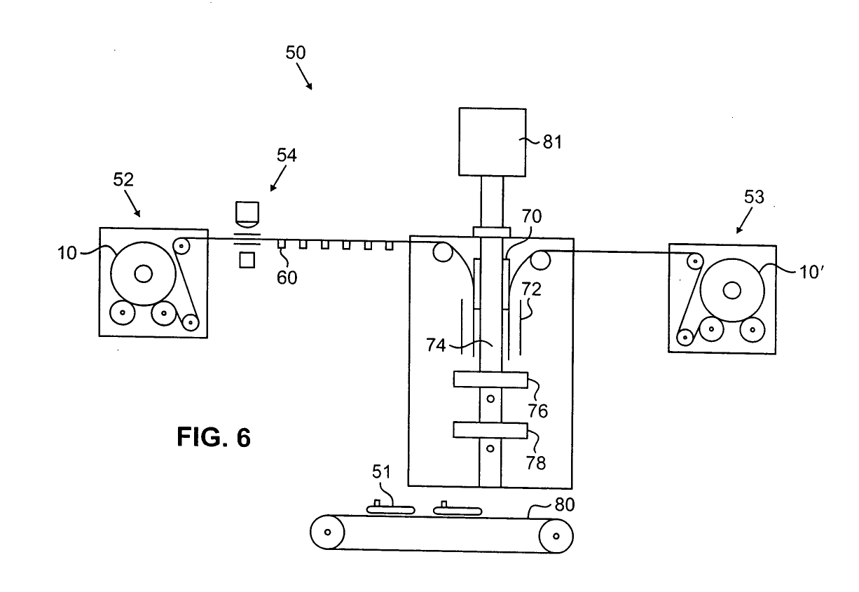

FIG. 6 shows the use of the multiple-ply roll 10 of material for use in package forming machinery, and more particularly, in vertical form, fill, and seal (VFFS) machinery 50 for making containers 51 with a liquid content in the range of about 5 to 20 liters. The VFFS machinery 50 has a support 52 for one supply roll of film material 10 and optionally a second support 53 for a second supply roll of film material 10′. Guide rollers or other support structures are provided to support and guide a web of film drawn from the one or both of the supply rolls to direct the film material along a feed path. A fitment attaching station 54 is optionally provided in the feed path for attaching a fluid access member 60 to a planar surface of one of the webs of film material 14 drawn from the supply roll 10.

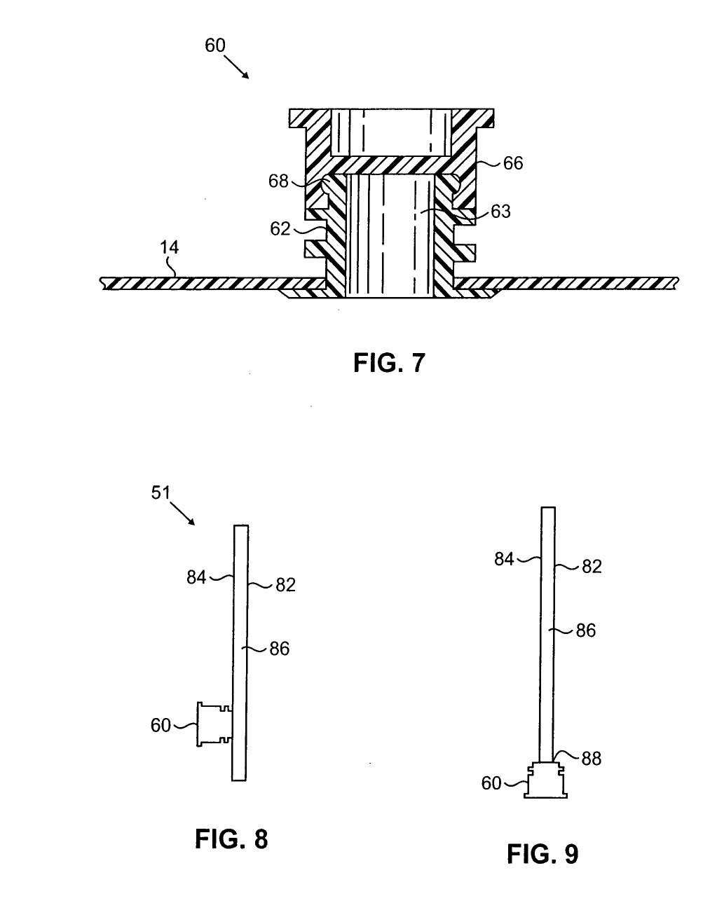

FIG. 7 shows the fluid access member or fitment 60 has a generally cylindrical wall 62 defining a fluid pathway 63 therein. The wall 62 extends axially from a circular flange 64. A cap 66 can be attached to the tube 62 with a set of mating threads 68 located on interfacing portions of the cap and wall. In one preferred form of the invention, a generally circular hole is cut through the web of material 14 and the tube 62 is inserted through the hole and the flange 64 is attached to a planar surface of the web of material 14 by heat sealing or other suitable attaching technique. The fitment 60 allows for access to a fluid chamber of a completed container from outside the container.

A film feed drive (not shown) is provided in the VFFS machinery 50 for displacing the film sheet or sheets along the feed path and through a pouch former 70. In embodiments utilizing two supply rolls of film 10 and 10′ as shown, the two sheets of film are brought into the pouch forming section 70 where the two sheets of material are positioned to place the opposed lateral edges of each sheet of film material into registration with one another and are welded together by heat welding apparatus 72 to form a tube disposed about a drop tube 74 having a liquid fill tube therein. A horizontally extending sealing apparatus 76 forms a bottom seal for a pouch to be filled and a top seal for a filled pouch. A severing apparatus 78 detaches the filled pouch from the pouch to be filled and the severed pouch drops from the container into an area adjacent the VFFS machinery 50 where the filled pouch will be prepared for shipping. FIG. 6 shows the filled containers 51 on an optional conveyor belt 80 where the filled containers are moved to an area away from the machinery 51 where they will be prepared for use or shipping. A support member (not shown) is provided to support a pouch while it is being filled to prevent the weight of the liquid in the pouch from tensioning the film at a time when the film experiences a loss of surface tension due to heating of the film by the horizontal sealing apparatus 76. The support apparatus also constrains the pouch being filled to prevent it from ballooning out during the filling cycle. The support apparatus has a discharge gate section to discharge the filled pouch after the horizontal sealing cycle.

In embodiments using two separate rolls of film, as shown in FIG. 6, at least one of the rolls 10 or 10′ will be the multiple-ply roll 10 described herein. The second supply roll of film 10′ can be a multiple-ply roll having or a single ply roll. If the second supply roll of film 10′ is a multiple-ply roll it can have the same number or a different number of plies as the first supply roll, it can have the same types of materials or different materials as the first roll, it can have the same order of layers of material in the stack or a different order of materials in the stack and any combination of these variables.

In embodiments of VFFS machinery using a single roll of multiple ply film the machinery can make both sidewalls of the multiple ply film or it can separate the stack of plies into a first ply or stack of plies and a second ply or stack of plies to make a first sidewall from the first ply or a stack of plies and a second sidewall from the second ply or stack of plies. In both embodiment the film material will either be folded or otherwise positioned to form a tubular web of material about the filling tube 74 and filled and sealed as described above in reference to FIG. 6.

The fluid filled into the container flows from a container 81 which is in liquid flow communication with the filling tube 74. Liquids that are commonly filled in this fashion using a VFFS machinery include wine, soft drink syrup concentrate, juices, medical solutions among numerous others.

FIGS. 8 and 9 show the filled container 51 having opposed walls 82 and 84 defining the fluid chamber 86. The container 51 is shown having two opposed walls to form a pillow type container but it is contemplated that additional walls could be used to form gussets or to form a stand up container or the like as is well known to those skilled in the art. The container 51 is shown with the optional fitment 60 that provides fluid access to the fluid chamber 86 from outside the container 51. The fitment can be attached to the planar surface as described above in reference to FIG. 6, or it can be attached in a separate operation. It is also contemplated that the fitment could be modified to have a flange portion extending between the sidewalls of the container and being attached to both sidewalls and having a portion extending outside of the container as shown in FIG. 9.

Suitable fitments 60 are well known to those skilled in the art and include fitments having portions for dispensing wine or docking to a line of a soda fountain, or that can be poured from, can be accessed through a straw or that can be directly drank from or that has a recloseable tap or the like. These parts can be formed from polymeric materials using injection molding techniques or the like.

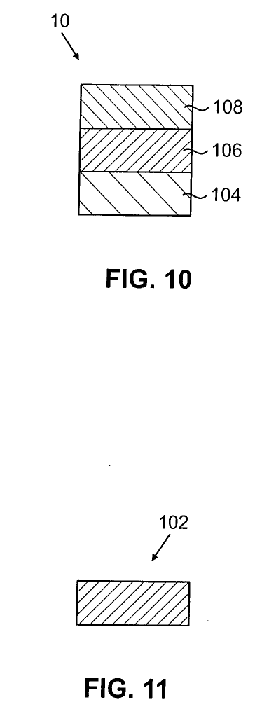

FIGS. 10 and 11 show respectively a multiple layer film structure 100 and a monolayer film structure 102 that can be used to form a ply of the multiple-ply rolls or single-ply rolls of material 10, 10′ discussed above. The multiple layer structure 100 can have from 2 to 10 layers, for example, and is shown in FIG. 10 having three layers. It should be understood that the individual layers of the multiple layer structure are attached or connected from one lateral edge to the other unlike the multiple ply structures material 14. While tie layers are not shown, it is contemplated that tie layers may be positioned between layers to prevent delamination of the multiple layer structure or to provide other physical properties needed from the structure. The multiple layer structure and the monolayer structure can be formed using polymer forming techniques well known to those skilled in the art including extrusion, coextrusion, extrusion lamination, lamination, blown extrusion and the like. Suitable material for forming a layer of the film includes polymeric material, paper and metal foil.

Suitable polymeric material includes polyolefins, ethylene and lower alkyl acrylate copolymers, ethylene and lower alkyl substituted alkyl acrylate copolymers, ethylene vinyl acetate copolymers, polyimides, polysulfones, polycarbonates, polyethers, polyetheramides, polyetherimides, polystyrenes, ethylene vinyl alcohols, ethylene vinyl acetates, polyvinyl chlorides, polyvinyledine chlorides, polybutadienes, polyesters, polyamides, polystyrenes and styrene and hydrocarbon copolymers.

Suitable polyolefins include homopolymers and copolymers obtained by polymerizing alpha-olefins containing from 2 to 20 carbon atoms, and more preferably from 2 to 10 carbons. Therefore, suitable polyolefins include polymers and copolymers of propylene, ethylene, butene-1, pentene-1, 4-methyl-1-pentene, hexene-1, heptene-1, octene-1, nonene-1 and decene-1. Most preferably the polyolefin is a homopolymer or copolymer of propylene or a homopolymer or copolymer of polyethylene.

Suitable homopolymers of polypropylene can have a stereochemistry of amorphous, isotactic, syndiotactic, atactic, hemiisotactic or stereoblock. In one preferred form of the invention the homopolymer of polypropylene is obtained using a single site catalyst.

Suitable copolymers of propylene are obtained by polymerizing a propylene monomer with an α-olefin having from 2 to 20 carbons. In a more preferred form of the invention, the propylene is copolymerized with ethylene in an amount by weight from about 1% to about 20%, more preferably from about 1% to about 10% and most preferably from 2% to about 5% by weight of the copolymer. The propylene and ethylene copolymers may be random or block copolymers. In a preferred form of the invention, the propylene copolymer is obtained using a single-site catalyst.

It is also possible to use a blend of polypropylene and α-olefin copolymers wherein the propylene copolymers can vary by the number of carbons in the α-olefin. For example, the present invention contemplates blends of propylene and α-olefin copolymers wherein one copolymer has a 2 carbon α-olefin and another copolymer has a 4 carbon α-olefin. It is also possible to use any combination of α-olefins from 2 to 20 carbons and more preferably from 2 to 8 carbons. Accordingly, the present invention contemplates blends of propylene and α-olefin copolymers wherein a first and second α-olefins have the following combination of carbon numbers: 2 and 6, 2 and 8, 4 and 6, 4 and 8. It is also contemplated using more than 2 polypropylene and α-olefin copolymers in the blend. Suitable polymers can be obtained using a catalloy procedure.

It may also be desirable to use a high melt strength polypropylene. High melt strength polypropylenes can be a homopolymer or copolymer of polypropylene having a melt flow index within the range of 10 grams/10 min. to 800 grams/10 min., more preferably 30 grams/10 min. to 200 grams/10 min, or any range or combination of ranges therein. High melt strength polypropylenes are known to have free-end long chain branches of propylene units. Methods of preparing polypropylenes which exhibit a high melt strength characteristic have been described in U.S. Pat. Nos. 4,916,198; 5,047,485; and 5,605,936 which are incorporated herein by reference and made a part hereof. One such method includes irradiating a linear propylene polymer in an environment in which the active oxygen concentration is about 15% by volume with high energy ionization energy radiation at a dose of 1 to 10⁴ megarads per minute for a period of time sufficient for a substantial amount of chain scission of the linear propylene polymer to occur but insufficient to cause the material to become gelatinous. The irradiation results in chain scission. The subsequent recombination of chain fragments results in the formation of new chains, as well as joining chain fragments to chains to form branches. This further results in the desired free-end long chain branched, high molecular weight, non-linear, propylene polymer material. Radiation is maintained until a significant amount of long chain branches form. The material is then treated to deactivate substantially all the free radicals present in the irradiated material.

High melt strength polypropylenes can also be obtained as described in U.S. Pat. No. 5,416,169, which is incorporated in its entirety herein by reference and made a part hereof, when a specified organic peroxide (di-2-ethylhexyl peroxydicarbonate) is reacted with a polypropylene under specified conditions, followed by melt-kneading. Such polypropylenes are linear, crystalline polypropylenes having a branching coefficient of substantially 1, and, therefore, has no free end long-chain branching and will have a intrinsic viscosity of from about 2.5 dl/g to 10 dl/g.

Suitable homopolymers of ethylene include those having a density of greater than 0.915 g/cc and includes low density polyethylene (LDPE), medium density polyethylene (MDPE) and high density polyethylene (HDPE).

Suitable copolymers of ethylene are obtained by polymerizing ethylene monomers with an α-olefin having from 3 to 20 carbons, more preferably 3-10 carbons and most preferably from 4 to 8 carbons. It is also desirable for the copolymers of ethylene to have a density as measured by ASTM D-792 of less than about 0.915 g/cc and more preferably less than about 0.910 g/cc and even more preferably less than about 0.900 g/cc. Such polymers are oftentimes referred to as VLDPE (very low density polyethylene) or ULDPE (ultra low density polyethylene). Preferably the ethylene α-olefin copolymers are produced using a single site catalyst and even more preferably a metallocene catalyst system. Single site catalysts are believed to have a single, sterically and electronically equivalent catalyst position as opposed to the Ziegler-Natta type catalysts which are known to have a mixture of catalysts sites. Such single-site catalyzed ethylene α-olefins are sold by Dow under the trade name AFFINITY, DuPont Dow under the trademark ENGAGE® and by Exxon under the trade name EXACT. These copolymers shall sometimes be referred to herein as m-ULDPE.

Suitable copolymers of ethylene also include ethylene and lower alkyl acrylate copolymers, ethylene and lower alkyl substituted alkyl acrylate copolymers and ethylene vinyl acetate copolymers having a vinyl acetate content of from about 8% to about 40% by weight of the copolymer. The term “lower alkyl acrylate” refers to comonomers having the formula set forth in Diagram 1:

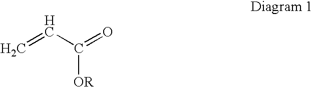

The R group refers to alkyls having from 1 to 17 carbons. Thus, the term “lower alkyl acrylates” includes but is not limited to methyl acrylate, ethyl acrylate, butyl acrylate and the like.

The term “alkyl substituted alkyl acrylates” refers to comonomers having the formula set forth in Diagram 2:

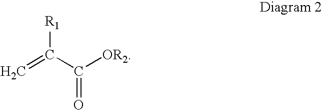

R₁ and R₂ are alkyls having 1-17 carbons and can have the same number of carbons or have a different number of carbons. Thus, the term “alkyl substituted alkyl acrylates” includes but is not limited to methyl methacrylate, ethyl methacrylate, methyl ethacrylate, ethyl ethacrylate, butyl methacrylate, butyl ethacrylate and the like.

Suitable polybutadienes include the 1,2- and 1,4-addition products of 1,3-butadiene (these shall collectively be referred to as polybutadienes). In a more preferred form of the invention, the polymer is a 1,2-addition product of 1,3 butadiene (these shall be referred to as “1,2 polybutadienes”). In an even more preferred form of the invention, the polymer of interest is a syndiotactic 1,2-polybutadiene and even more preferably a low crystallinity, syndiotactic 1,2 polybutadiene. In a preferred form of the invention, the low crystallinity, syndiotactic 1,2 polybutadiene will have a crystallinity less than 50%, more preferably less than about 45%, even more preferably less than about 40%, even more preferably the crystallinity will be from about 13% to about 40%, and most preferably from about 15% to about 30%. In a preferred form of the invention, the low crystallinity, syndiotactic 1,2 polybutadiene will have a melting point temperature measured in accordance with ASTM D 3418 from about 70° C. to about 120° C. Suitable resins include those sold by JSR (Japan Synthetic Rubber) under the grade designations: JSR RB 810, JSR RB 820, and JSR RB 830.

Suitable polyesters include polycondensation products of di-or polycarboxylic acids and di or poly hydroxy alcohols or alkylene oxides. In one preferred form of the invention the polyester is a polyethylene terephthalate (PET) or PET ethylene glycol modified. In another form of the invention, the polyester is a polyester ether. Suitable polyester ethers are obtained from reacting 1,4 cyclohexane dimethanol, 1,4 cyclohexane dicarboxylic acid and polytetramethylene glycol ether and shall be referred to generally as PCCE. Suitable PCCE's are sold by Eastman under the trade name ECDEL. Suitable polyesters further include polyester elastomers which are block copolymers of a hard crystalline segment of polybutylene terephthalate and a second segment of a soft (amorphous) polyether glycols. Such polyester elastomers are sold by Du Pont Chemical Company under the trade name HYTREL®.

Suitable polyamides include those that result from a ring-opening reaction of lactams having from 4-12 carbons. This group of polyamides therefore includes nylon 6, nylon 10 and nylon 12. Acceptable polyamides also include aliphatic polyamides resulting from the condensation reaction of di-amines having a carbon number within a range of 2-13, aliphatic polyamides resulting from a condensation reaction of di-acids having a carbon number within a range of 2-13, polyamides resulting from the condensation reaction of dimer fatty acids, and amide containing copolymers. Thus, suitable aliphatic polyamides include, for example, nylon 6,6 nylon 6,10 and dimer fatty acid polyamides.

The styrene of the polystyrene and the styrene and hydrocarbon copolymer includes styrene and the various substituted styrenes including alkyl substituted styrene and halogen substituted styrene. The alkyl group can contain from 1 to about 6 carbon atoms. Specific examples of substituted styrenes include alpha-methylstyrene, beta-methylstyrene, vinyltoluene, 3-methylstyrene, 4-methylstyrene, 4-isopropylstyrene, 2,4-dimethylstyrene, o-chlorostyrene, p-chlorostyrene, o-bromostyrene, 2-chloro-4-methylstyrene, etc. Styrene is the most preferred.

The hydrocarbon portion of the styrene and hydrocarbon copolymer includes conjugated dienes. Conjugated dienes which may be utilized are those containing from 4 to about 10 carbon atoms and more generally, from 4 to 6 carbon atoms. Examples include 1,3-butadiene, 2-methyl-1,3-butadiene (isoprene), 2,3-dimethyl- 1,3-butadiene, chloroprene, 1,3-pentadiene, 1,3-hexadiene, etc. Mixtures of these conjugated dienes also may be used such as mixtures of butadiene and isoprene. The preferred conjugated dienes are isoprene and 1,3-butadiene.

The styrene and hydrocarbon copolymers can be block copolymers including di-block, tri-block, multi-block, star block, and mixtures thereof Specific examples of diblock copolymers include styrene-butadiene, styrene-isoprene, and the hydrogenated derivatives thereof. Examples of triblock polymers include styrene-butadiene-styrene, styrene-isoprene-styrene, alpha-methylstyrene-butadiene-alpha-methylstyrene, and alpha-methylstyrene-isoprene-alpha-methylstyrene and hydrogenated derivatives thereof.

The selective hydrogenation of the above block copolymers may be carried out by a variety of well known processes including hydrogenation in the presence of such catalysts as Raney nickel, noble metals such as platinum, palladium, etc., and soluble transition metal catalysts. Suitable hydrogenation processes which can be used are those wherein the diene-containing polymer or copolymer is dissolved in an inert hydrocarbon diluent such as cyclohexane and hydrogenated by reaction with hydrogen in the presence of a soluble hydrogenation catalyst. Such procedures are described in U.S. Pat. Nos. 3,113,986 and 4,226,952, the disclosures of which are incorporated herein by reference and made a part hereof.

Particularly useful hydrogenated block copolymers are the hydrogenated block copolymers of styrene-isoprene-styrene, such as a styrene-(ethylene/propylene)-styrene block polymer. When a polystyrene-polybutadiene-polystyrene block copolymer is hydrogenated, the resulting product resembles a regular copolymer block of ethylene and 1-butene (EB). As noted above, when the conjugated diene employed is isoprene, the resulting hydrogenated product resembles a regular copolymer block of ethylene and propylene (EP). One example of a commercially available selectively hydrogenated is KRATON G-1652 which is a hydrogenated SBS triblock comprising 30% styrene end blocks and a midblock equivalent is a copolymer of ethylene and 1-butene (EB). This hydrogenated block copolymer is often referred to as SEBS. Kraton G-1657 is a blend of SEBS triblock and SBS diblock which is also suitable. Other suitable SEBS or SIS copolymers are sold by Kurary under the tradename SEPTON® and HYBRAR®.

It may also be desirable to use graft modified styrene and hydrocarbon block copolymers by grafting an alpha,beta-unsaturated monocarboxylic or dicarboxylic acid reagent onto the selectively hydrogenated block copolymers described above.

The block copolymers of the conjugated diene and the vinyl aromatic compound are grafted with an alpha,beta-unsaturated monocarboxylic or dicarboxylic acid reagent. The carboxylic acid reagents include carboxylic acids per se and their functional derivatives such as anhydrides, imides, metal salts, esters, etc., which are capable of being grafted onto the selectively hydrogenated block copolymer. The grafted polymer will usually contain from about 0.1 to about 20%, and preferably from about 0.1 to about 10% by weight based on the total weight of the block copolymer and the carboxylic acid reagent of the grafted carboxylic acid. Specific examples of useful monobasic carboxylic acids include acrylic acid, methacrylic acid, cinnamic acid, crotonic acid, acrylic anhydride, sodium acrylate, calcium acrylate and magnesium acrylate, etc. Examples of dicarboxylic acids and useful derivatives thereof include maleic acid, maleic anhydride, fumaric acid, mesaconic acid, itaconic acid, citraconic acid, itaconic anhydride, citraconic anhydride, monomethyl maleate, monosodium maleate, etc.

The styrene and hydrocarbon block copolymer can be modified with an oil such as the oil modified SEBS sold by the Shell Chemical Company under the product designation KRATON G2705.

It is also contemplated the layers can be formed from polymer blends of the components described above.

In a preferred form of the invention, the multiple layer structure 100 will have a first solution contact layer 104 of a polyethylene, a second intermediate layer 106 of a polyamide or an ethylene vinyl alcohol copolymer and an outer layer 108 of a polyamide or an ethylene vinyl alcohol copolymer. It is contemplated using tie layers (not shown) or adhesives between these layers. In a preferred form of the invention, the monolayer structure will be a polyethylene.

Also, in a most preferred form of the invention one of the first ply or the second ply will be fabricated from the multiple layer structure 100 and the other ply will be formed from the monolayer structure. In a most preferred form of the invention, one container wall will be formed from a two ply structure 20, 22 having the first ply 20 of a multiple layer structure. Even more preferably the multiple layer structure of ply 20 will have layers stacked in an order, from solution contact layer to outer layer, of polyethylene/tie/ethylene vinyl alcohol or polyamide/tie/ethylene vinyl alcohol or polyamide. The second ply 22 will be of a monolayer structure 102 and even more preferably of polyethylene. The opposed wall of the container will be formed from a monolayer structure and even more preferably a polyethylene.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims

We claim:

1. A roll of film material comprising:
a first web of film having a first planar surface and a first set of opposed lateral edges;
a second web of film having a second planar surface and a second set of opposed lateral edges, a portion of the second planar surface being in contact with the first planar surface but not being attached thereto, the second set of opposed lateral edges being in registration with the first set of opposed lateral edges; and
the first web of film and the second web of film being wound about an axis transversely disposed to the first set of opposed lateral edges to define a roll of film material.

2. The roll of claim 1 wherein the first web of film and the second web of film comprise polymeric material.

3. The roll of claim 2 wherein the polymeric material comprises thermoplastic polymer material.

4. The roll of claim 1 wherein the first web is a multiple layer polymeric material.

5. The roll of claim 4 wherein the second web has a structure selected from the group consisting of a monolayer polymeric material and a multiple layer polymeric material.

6. The roll of claim 4 wherein the multiple layer polymeric material has a first layer of a polyolefin.

7. The roll of claim 6 wherein the polyolefin comprises homopolymers, copolymers and terpolymers having monomers selected from the group consisting of propylene, ethylene, butene, pentene, hexene, heptene, octene, and nonene.

8. The roll of claim 6 wherein the first layer is of a material selected from the group consisting of high density polyethylene, medium density polyethylene, low density polyethylene, linear low density polyethylene and ultra-low density polyethylene.

9. The roll of claim 6 wherein the multiple layer polymeric material has a second layer attached to the first layer of a material selected from the group consisting of polyolefins, ethylene and lower alkyl acrylate copolymers, ethylene and lower alkyl substituted alkyl acrylate copolymers, ethylene vinyl acetate copolymers, polyimides, polysulfones, polycarbonates, polyethers, polyetheramides, polyetherimides, polystyrenes, ethylene vinyl alcohols, ethylene vinyl acetates, polyvinyl chlorides, polyvinyledine chlorides, polybutadienes, polyesters, polyamides, polystyrenes and styrene and hydrocarbon copolymers.

10. The roll of claim 9 wherein the multiple layer polymeric material has a third layer attached to the second layer.

11. The roll of claim 1 wherein a portion of one of the first lateral edges is welded to a portion of one of the second lateral edges.

12. A method for forming a roll of multiple plies of material comprising:
providing a first source of a first web of polymeric material and having a first planar surface disposed between a first set of opposed lateral edges;
providing a second source of a second web of material having a second planar surface disposed between a second set of opposed lateral edges;
drawing the first web of material from the first source and drawing the second web of material from the second source;
contacting a portion of the first planar surface with a portion of the second planar surface to form a multiple-ply structure; and
winding the multiple-ply structure about an axis transverse to the first set of opposed lateral edges to define the roll.

13. The method of claim 12 further comprising positioning one of the first web or the second web with respect to the other to bring the first pair of lateral edges into registration with the second set of lateral edges.

14. The method of claim 13 further comprising attaching one of the first set of opposed lateral edges to one of the second set of opposed lateral edges.

15. The method of claim 12 wherein the first web of material has a multiple layer structure having a first layer of a material selected from polyolefins and a second layer of material attached to the first layer, the second layer being selected from the group consisting of polyolefins, ethylene and lower alkyl acrylate copolymers, ethylene and lower alkyl substituted alkyl acrylate copolymers, ethylene vinyl acetate copolymers, polyimides, polysulfones, polycarbonates, polyethers, polyetheramides, polyetherimides, polystyrenes, ethylene vinyl alcohols, ethylene vinyl acetates, polyvinyl chlorides, polyvinyledine chlorides, polybutadienes, polyesters, polyamides, polystyrenes and styrene and hydrocarbon copolymers

16. The method of claim 12 wherein the first web of material comprises a first layer forming an outer layer of a polyolefin, a second layer of material attached to the first layer and being selected from the group consisting of polyamides, polyesters and ethylene vinyl alcohol and a third layer attached to the second layer and being selected from the group consisting of polyamides, polyesters and ethylene vinyl alcohol.

17. The method of claim 16 wherein the second web of material is a monolayer structure comprising a polyolefin.

18. The method of claim 16 wherein the first source of material comprises non-molten film material stored in a roll.

19. The method of claim 16 wherein the first source of material is provided directly from an extrusion die.

20. The method of claim 19 wherein the extrusion die simultaneously provides a first web of material and a second web of material not connected to the first web of material.

21. A method for forming a container in a vertical form, fill and seal machinery comprising:
providing a spool of container wall material having at least a first ply and a second ply, the first ply having a first length and a first planar surface extending between a first set of opposed lateral edges, the second ply having a second length and having a second planar surface extending between a second pair of opposed lateral edges, the spool having an axis and a generally circular cross sectional shape when viewed down the axis and a height, the first planar surface contacting the second planar surface to form a plurality of consecutive layers for a portion of the height;
unspooling a portion of each of the first ply and the second ply from the spool to define an unspooled length of material;
forming a portion of a container having a fluid chamber from the unspooled length of material; and
filling the fluid chamber with a fluid.

22. The method of claim 21 wherein a portion of the first set of opposed lateral edges are in registration with the second set of opposed lateral edges and attached thereto to define a first sidewall of the container.

23. The method of claim 22 wherein the first sidewall is attached to an opposed second sidewall to form the container.

24. The method of claim 21 wherein the first ply defines a first sidewall of the container and the second ply defines a second sidewall opposed to the first sidewall to form a container defining the fluid chamber.

25. The method of claim 21 wherein the container is a pouch with an open end and the fluid is provided under pressure through the open end into the fluid chamber.
